(19) United States
(12) Patent Application Publication
(10) Pub. No.: US 2014/0181962 A1
(43) Pub. Date: Jun. 26, 2014

(54) APPLICATION EXECUTING METHOD USING FINGERPRINT RECOGNITION, DEVICE THEREFOR, AND COMPUTER READABLE RECORDING MEDIUM THEREFOR

(71) Applicants: CRUCIALSOFT COMPANY, Seoul (KR); CRUCIALTEC CO.,LTD., Chungcheongnam-do (KR)

(72) Inventors: Jong Chul SEO, Gyeonggi-do (KR); Jung Je PARK, Seoul (KR); Hyo Min JOO, Gyeonggi-do (KR); Jae Han KIM, Gyeonggi-do (KR); Jun Woo PARK, Seoul (KR); Chae Woong LIM, Seoul (KR)

(73) Assignees: CRUCIALSOFT COMPANY, Seoul (KR); CRUCIALTEC CO.,LTD., Chungcheongnam-do (KR)

(21) Appl. No.: 14/132,816

(22) Filed: Dec. 18, 2013

(30) Foreign Application Priority Data
Dec. 20, 2012 (KR) 10-2012-0149207

(51) Int. Cl. G06F 21/32

(52) U.S. Cl. CPC G06F 21/32
USPC 726/19

(57) ABSTRACT

An application-executing method using fingerprint recognition wherein an application-executing device executes an application using fingerprint recognition, includes recognizing a fingerprint from a fingerprint image obtained through a fingerprint sensor in a locking state of the application-executing device, activating a specific area that is part of a locking state screen of the application-executing device when the fingerprint is recognized, displaying a list of a plurality of applications in the specific area, receiving selection information of at least one application from the list of the plurality of applications, and executing an application according to the selected information.

### CROSS-REFERENCE TO RELATED APPLICATIONS

This application claims priority to Korean Patent Application No. 2012-0149207 filed on Dec. 20, 2012 in the Korean Intellectual Property Office (KIPO), the entire contents of which are hereby incorporated in their entirety by reference.

### BACKGROUND

1. Field of the Invention

The present invention relates to a method, device, and computer readable recording medium using fingerprint recognition, and more specifically, a method, device, and computer readable recording medium for executing an application using fingerprint recognition.

2. Description of Related Art

Recently, various additional functionality using personal information, such as mobile banking, in addition to communication functionality, such as making a call or sending a text message via a transmission service, have been provided for users through mobile communication terminals. Accordingly, the necessity and importance of a locking device for the mobile communication terminals are being highlighted herein.

Existing locking devices applied to mobile communication terminals mostly use a password-mediated traditional method. For example, a locking device may be applied to call functions, additional non-call based functions, or international calling functions.

However, this method has problems in that it is useless when the password is disclosed, and its further futility is manifested in needing to change the password periodically in order to secure its safety, and lastly, users have to actually remember the password.

Recently, in order to complement this security method and improve its locking effectiveness, terminals employing a locking device using fingerprint recognition have been under earnest development.

In order to install an application-executing device using fingerprint recognition within the mobile communication terminal, and the manufacturing of the fingerprint recognition apparatus in small sizes, it is necessary to minimize the fingerprint sensor size. According to this requirement, a “slide-type” fingerprint recognition sensor wherein a fingerprint is recognized by swiping the finger on a bar-type sensor extending from side-to-side is under development.

Concurrently, because the fingerprint recognition sensor is typically installed within the mobile communication terminal, efforts for incorporating the sensor with other functionality have been realized.

### SUMMARY

Example embodiments are provided to improve user convenience by executing an application in a locking state screen through fingerprint recognition.

According to an aspect of the invention, provided is an application-executing method using fingerprint recognition wherein an application-executing device executes an application using fingerprint recognition. The method includes recognizing a fingerprint from a fingerprint image obtained through a fingerprint sensor in a locking state of the application-executing device, activating a specific area that is part of a locking state screen of the application-executing device when the fingerprint is recognized, displaying a list of a plurality of applications in the specific area, receiving selection information of at least one application from the list of the plurality of applications, and executing an application according to the selected information. The list of the plurality of applications may include at least one of an application that was recently executed by the application-executing device, a currently executing application, and an application that was previously designated as an application to be displayed in the specific area.

According to another aspect of the invention, provided is an application-executing device using fingerprint recognition. The device includes a fingerprint sensor configured to obtain an image of a fingerprint in a locking state of an application-executing device and recognize the fingerprint, a screen control unit configured to control, when the fingerprint is recognized by the fingerprint sensor, a specific area that is part of a locking state screen of the application-executing device when it is activated and when the list of the plurality of applications is displayed in the specific area, a selection information receiving unit configured to receive selection information of at least one application on the list of the plurality of applications, and an application-executing unit configured to execute an application according to the selected information.

The list of a plurality of applications may include at least one of an application that was recently executed by the application-executing device, a currently executing application, and an application that was previously designated as an application to be displayed in the specific area.

According to still yet another aspect of the invention, provided is a computer readable recording medium for recording a method of executing an application using fingerprint recognition, and a computer program that executes the method.

### BRIEF DESCRIPTION OF THE DRAWINGS

FIG. 1 is a diagram illustrating an overall configuration of an application-executing device, using fingerprint recognition, according to an embodiment of the invention.

FIG. 2 includes illustrations of exemplary fragmented fingerprint images obtained by a fingerprint sensor, according to an embodiment of the invention.

FIG. 3 is a block diagram illustrating an internal configuration of the application-executing device using fingerprint recognition, according to an embodiment of the invention.

FIG. 4 is a flowchart illustrating an application executing method using fingerprint recognition, according to another embodiment of the invention.

FIG. 5 includes illustrations of screens wherein the application-executing method using fingerprint recognition is implemented, according to another embodiment of the invention.

### DETAILED DESCRIPTION

Detailed descriptions of the invention will be made with reference to the accompanying drawings illustrating specific embodiments of the invention as examples. These embodiments will be described in detail such that the invention can be performed by those skilled in the art. It should be understood that various embodiments of the invention are different, but are not necessarily mutually exclusive. For example, a specific shape, structure, and characteristic of an embodiment described herein may be implemented in another embodiment without departing from the scope and spirit of the invention. In addition, it should be understood that a position or an arrangement of each component in each disclosed embodiment may be changed without departing from the scope and spirit of the invention. Accordingly, there is no intent to limit the invention to the detailed descriptions to be described below. The scope of the invention is defined by the appended claims and encompasses all equivalents that fall within the scope of the appended claims. Like numbers refer to the same or like functions throughout the description of the figures.

Hereinafter, in order to easily perform the invention by those skilled in the art, exemplary embodiments of the invention will be described in detail with reference to the accompanying drawings.

Operations of the application-executing device using fingerprint recognition.

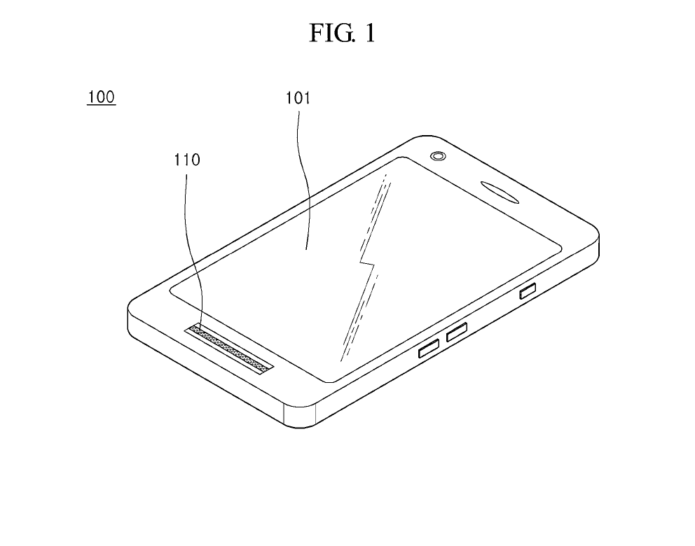

FIG. 1 is a diagram illustrating a structure of an application-executing device using fingerprint recognition 100, according to an embodiment of the invention.

As illustrated in FIG. 1, at least a portion of an application-executing device using fingerprint recognition 100, may include a fingerprint sensor 110. In the drawing, although the fingerprint sensor 110 is formed on an edge of the application-executing device using fingerprint recognition 100, the sensor may be formed anywhere, and the modification hereby falls within the scope of the invention.

The application-executing device using fingerprint recognition 100, according to one embodiment, may include a digital device that performs a predetermined data process and performs a user-desired operation. The application-executing device using fingerprint recognition 100, may include an input unit and a display unit 101. The state of an operation, performed by a predetermined operation command from of a user through the input unit, may be provided to the user through the display unit 101. Although the display unit 101 of the application-executing device using fingerprint recognition 100, is implemented as a touch screen method, and performs the function of the input unit at the same time, as in FIG. 1, the input unit may be separately provided from the display unit 101, for example, as a keyboard or a keypad method.

The application-executing device using fingerprint recognition 100, according to one embodiment, may be understood as the term “application-executing” encompasses a digital device, including a memory unit and a microprocessor having a computational capability, for example, a tablet PC, a smart phone, a personal computer, a workstation, a PDA, a web pad, a mobile phone, and a navigation device, or the like.

The fingerprint sensor 110, according to one embodiment, may be implemented as a slide-type. The slide-type fingerprint sensor 110 performs fingerprint recognition wherein a fingerprint of a finger moving in a sliding manner is sensed, and fragmented fingerprint images are read, these fragmented fingerprint images are matched into one image, and then a complete fingerprint image is implemented.

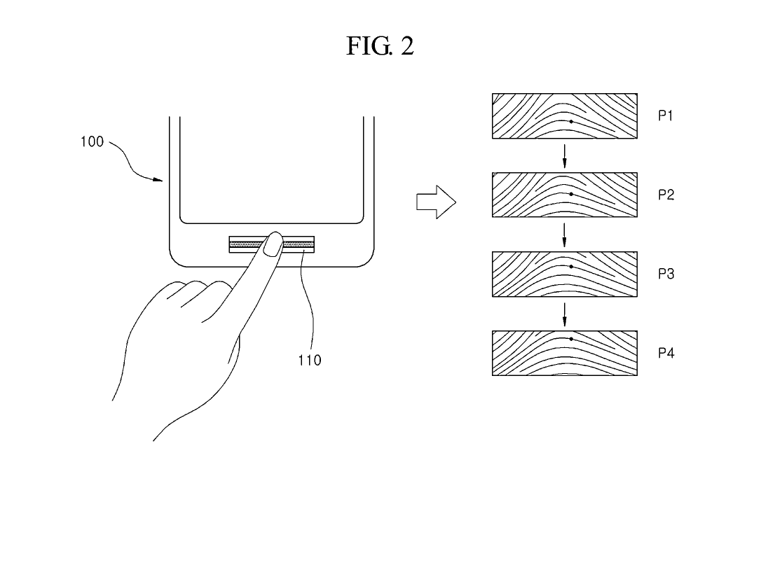

FIG. 2 includes illustrations of exemplary fragmented fingerprint images obtained by the slide-type fingerprint sensor 110, as illustrated in FIG. 1. For example, when the user moves his or her thumb while touching the fingerprint sensor 110 in a sliding manner, partial fragmented images (P1 to P4) are consecutively obtained.

As such, the user fingerprint images are fragmented, but consecutively obtained in a successive manner. The fragmented fingerprint images read by the fingerprint sensor 110 are then matched into one fingerprint image.

According to one embodiment, the matching fingerprint image may be compared with a pre-registered fingerprint image and used as a method for validating a corresponding user. More specifically, a registered fingerprint image of the user may be stored in a database (not illustrated) of the application-executing device using fingerprint recognition 100, the completed fingerprint image obtained by the fingerprint sensor 110 may be compared with a completed fingerprint image stored in the database, and thus user authentication may be performed.

According to another embodiment, the matching fingerprint image may be compared with at least one pre-registered fingerprint image and used as a command for performing a specific operation. For example, specific operations of matching fingerprints of fingers of the user are stored, and when the matching fingerprint image obtained by the fingerprint sensor 110 matches a fingerprint image of a specific finger, a specific matching operation may be performed. This is referred to as a “quick-launch” function in this specification. For example, the user may set, in advance, that when a thumb fingerprint of a valid user is recognized, a first application is executed and when an index finger fingerprint of a valid user is recognized, a second application is executed. Then, the user moves his or her thumb in a sliding manner while touching the fingerprint sensor 110. When the matching fingerprint image obtained by the fingerprint sensor 110 matches a pre-registered fingerprint image of the thumb, a matching operation or “quick-launch”, that is, an execution operation of the first application is performed.

Internal configuration of application-executing device using fingerprint recognition 100.

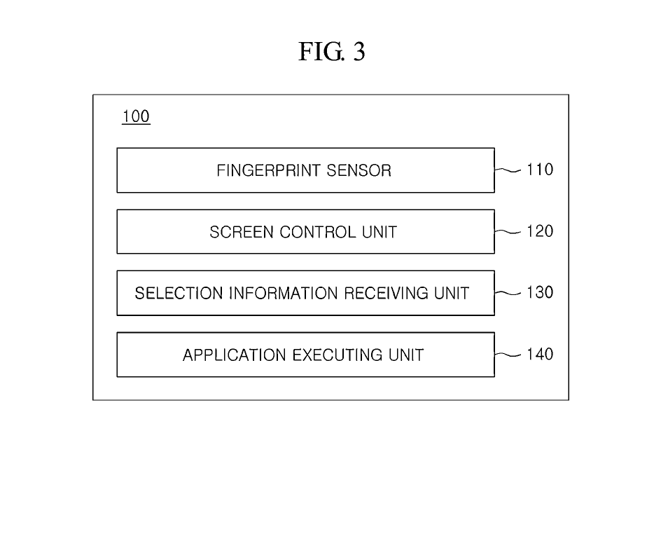

FIG. 3 is a diagram illustrating an internal configuration of the application-executing device using fingerprint recognition 100, according to the embodiment of the invention.

As illustrated in FIG. 3, the application-executing device using fingerprint recognition 100, according to one embodiment, includes a fingerprint sensor 110, a screen control unit 120, a selection information receiving unit 130, and an application-executing unit 140.

According to one embodiment of the invention, each of the fingerprint sensor 110, the screen control unit 120, the selection information receiving unit 130, and the application-executing unit 140 may be a program module or hardware. These program modules or hardware may be included in the application-executing device using fingerprint recognition 100, or another device capable of data communicating with the application-executing device 100 in the form of an operating system, an application program module, and a program module, and may be physically stored in various well-known recording devices. Concurrently, these program modules or hardware include routines, subroutines, programs, objects, components, data structures, or the like, which perform, without limitation, a specific task to be described below and execute a specific abstract data type.

The fingerprint sensor 110, according to one embodiment, may be implemented as a slide-type fingerprint sensor, as described with reference to FIGS. 1 and 2. When the user touches a finger on the recognition window of the fingerprint sensor 110 and slides the finger at a predetermined speed, a corresponding fingerprint is scanned, and fragmented fingerprint images may be obtained. As such, the fingerprint sensor 110, according to one embodiment, obtains a fingerprint image and recognizes a fingerprint based on the obtained fingerprint image. The fingerprint sensor 110 may be the slide-type fingerprint sensor, and the slide-type fingerprint sensor may be also referred to as a “bar-type” or a “straight-type” fingerprint sensor, according to the form of the recognition window.

When the user's fingerprint is recognized by the fingerprint sensor 110, the screen control unit 120 activates a specific area that is part of a locking state screen of the application-executing device using fingerprint recognition 100, and displays a list of a plurality of applications in the specific area.

According to one embodiment, the entire portion of the locking state screen of the application-executing device using fingerprint recognition 100 may be in an inactive state for touch signal detection other than the portion for locking release. Therefore, even when a touch signal is input into the locking state screen of the inactive state, the application-executing device 100 may not be operated.

When the fingerprint is recognized by the fingerprint sensor 110, the screen control unit 120 activates the specific area that is part of the locking state screen of the application-executing device using fingerprint recognition 100. That is, the screen control unit 120 may control the screen wherein a touch signal can be detected in the specific area that is part of the locking state screen of the application-executing device using fingerprint recognition 100. The screen control unit 120 may display a list of a plurality of applications that can be executed in the application-executing device using fingerprint recognition 100, in the specific area wherein the touch signal detection was activated. In this way, since the list of the plurality of applications is displayed in the activated specific area, the list of the plurality of applications may detect the touch signal.

The selection information receiving unit 130 receives selection information of an application to be executed from the list of the plurality of applications from the user. The selection information receiving unit 130 receives selection information of at least one application on the list of the plurality of applications from the user.

In this case, the list of the plurality of applications may include at least one of an application that was recently executed by the application-executing device using fingerprint recognition 100, an application that is currently executing in the application-executing device using fingerprint recognition 100, and an application that was previously designated as an application to be displayed from an application list of the specific area by the user.

The application that was previously designated as an application to be displayed from an application list of the specific area by the user, may be an application that is frequently used by the user in the application-executing device using fingerprint recognition 100, or an application that was previously selected by the user for immediate use in the locking state screen.

The application-executing unit 140 executes an application according to the selection information received from the selection information receiving unit 130. That is, the application-executing unit 140 may execute an application that is selected via inputting a touch signal by the user from the list of the plurality of applications displayed in the locking state screen.

Application executing method using fingerprint recognition.

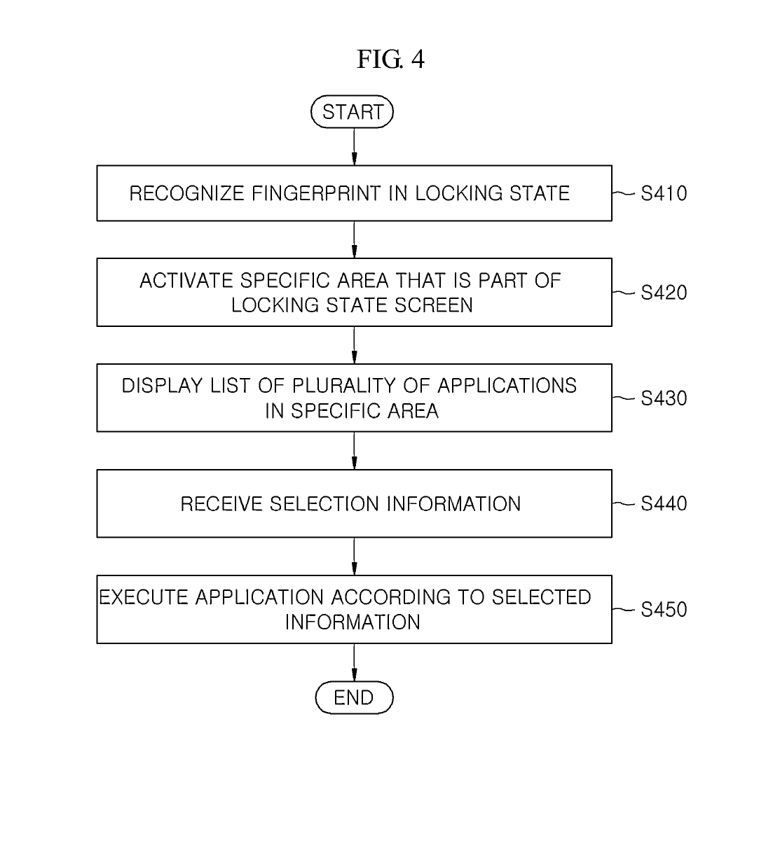

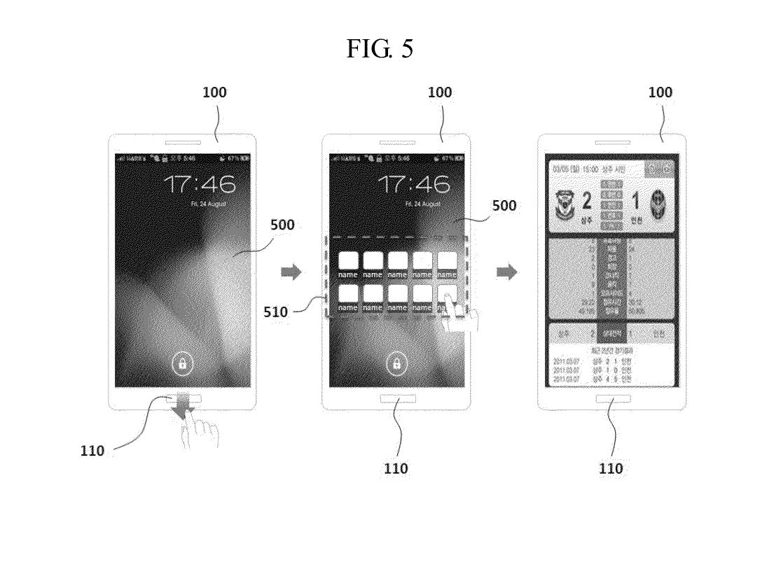

Hereinafter, an application-executing method using fingerprint recognition, according to another embodiment of the invention, will be described with reference to FIGS. 4 and 5. FIG. 4 is a flowchart illustrating the application-executing method using fingerprint recognition, according to another embodiment of the invention. FIG. 5 includes illustrations of screens wherein the application-executing method using fingerprint recognition is implemented, according to another embodiment of the invention.

The application-executing device using fingerprint recognition 100 recognizes a fingerprint from a fingerprint image obtained by touching a finger on the fingerprint sensor 110 in a locking state (S410).

As illustrated in FIG. 5, when the fingerprint is recognized, the application-executing device using fingerprint recognition 100 activates a specific area 510 that is part of a locking state screen 500, wherein touch signal detection is inactivated (S420), and displays the list of the plurality of applications in the specific area 510 (S430).

In this way, since the list of the plurality of applications is displayed in the specific area 510 wherein touch signal detection is activated, when selection information of an application to be executed from the plurality of applications is received from the user (S430), it is possible to execute the application corresponding to the selection information in the locking state screen (S440).

In this case, the entire portion, except the specific area 510, that is part of a locking state screen of the application executing device using fingerprint recognition 100, may be maintained in a locking state.

In this way, according to the invention, it is possible to execute the application even when in a terminal locking state via using fingerprint recognition, whereby this improves user convenience since the list of the plurality of applications is provided as the locking state screen in the locking state may include an application that was recently used, is currently being used, or will be designated by the user.

The above-described embodiments of the invention may be implemented as a form of a computer instruction that can be performed through various computer components, and may be recorded on computer readable recording media. The computer readable recording media may include a program instruction, a data file, and a data structure, and/or combinations thereof. The program instruction recorded on the computer readable recording media may be specially designed and prepared for the invention, or may be an available well-known instruction for those skilled in the field of computer software. Examples of the computer readable recording media include, magnetic media, such as a hard disk, a floppy disk, and a magnetic tape, optical media, such as a CD-ROM and a DVD, magneto-optical media, such as a floptical disk, and a hardware device, such as a ROM, a RAM, and a flash memory, that are specially made to store and perform instructions. Examples of the program instructions may include a machine code generated by a compiler and a high-level language code that can be executed in a computer using an interpreter. Such a hardware devices may be configured as at least one software-module in order to perform the operations of the invention, and vice versa.

According to the invention, it is possible to execute an application in a locking state screen using fingerprint recognition, and thus the user can quickly execute applications.

While the invention has been described with reference to specific details, such as detailed components, specific embodiments, and drawings, these are only examples to facilitate the overall understanding of the invention, hence, the invention is not limited thereto. It will be understood by those skilled in the art, that various modifications and alternations may be made.

Therefore, the spirit and scope of the invention is defined not by the detailed description of the invention, but by the appended claims, and encompasses all modifications and equivalents that fall within the scope of the appended claims.

What is claimed is:

1. An application-executing method using fingerprint recognition wherein an application-executing device executes an application using the fingerprint recognition, comprising:
recognizing a fingerprint from a fingerprint image obtained through a fingerprint sensor in a locking state of the application-executing device;
activating a specific area that is a part of a locking state screen of the application-executing device when the fingerprint is recognized;
displaying a list of a plurality of applications in the specific area;
receiving selection information of at least one application from the list of the plurality of applications; and
executing an application according to the selected information.

2. The method according to claim 1, wherein the list of the plurality of applications includes at least one of an application recently executed by the application executing device, a currently executing application, and an application previously designated as an application to be displayed in the specific area.

3. An application-executing device using fingerprint recognition, comprising:
a fingerprint sensor configured to obtain an image of a fingerprint in a locking state of an application-executing device and recognize the fingerprint;
a screen control unit configured control, when the fingerprint is recognized by the fingerprint sensor, a specific area that is a part of a locking state screen of the application-executing device when the specific area is activated and a list of a plurality of applications is displayed in the specific area;
a selection information receiving unit configured to receive selection information of at least one application from the list of the plurality of applications; and
an application-executing unit configured to execute an application according to the selected information.

4. The device according to claim 3, wherein the list of the plurality of applications includes at least one of an application that was recently executed by the application executing device, a currently executing application, and an application that was previously designated as an application to be displayed in the specific area.

5. A computer readable recording medium for recording a computer program that executes the method according to claim 1.
